(19) United States
(12) Patent Application Publication
(10) Pub. No.: US 2010/0075283 A1
(43) Pub. Date: Mar. 25, 2010

(54) Device and method for training underground storage tank operators

(76) Inventors: Raymond Rees, Muncie, IN (US); Kevin Cooper, Liberty Township, OH (US); James Allen, Muncie, IN (US); Steve Thickstun, Columbus, OH (US); Tim Thickstun, Columbus, OH (US)

Correspondence Address: INDIANO VAUGHAN LLP, ONE N. PENNSYLVANIA STREET, SUITE 1300, INDIANAPOLIS, IN, 46204, US

(21) Appl. No.: 12/586,144

(22) Filed: Sep. 17, 2009

Related U.S. Application Data
(60) Provisional application No. 61/192,390, filed on Sep. 18, 2008.

(51) Int. Cl. G09B 19/00

(52) U.S. Cl. 434/219

(57) ABSTRACT

Training system software is operable on a digital computer for providing training to operator trainees of underground storage tank containing facilities. The software is capable of delivering facility specific training materials specifically applicable to an operator-trainee's designated facility. The software includes generic content component training materials for providing training applicable to a plurality of facilities including the operator trainee's designated facility. The software also includes at least two sets of regional content component training materials. Each of the at least two sets provide training applicable to at least two, but less than the plurality of facilities to which the generic content component is applicable; and at least one of the sets includes regional content material applicable to the designated facility of the operator-trainer. Additionally, the software includes at least four sets of facility specific component training materials. Each of the at least four sets includes facility specific content material applicable to a single facility, and one of the at least four sets includes facility specific content material applicable to the operator trainee's designated facility.

### PRIORITY STATEMENT

The instant application claims the benefit of priority to Rees et al., Provisional Patent Application No. 61/192,390, that was filed on 18 Sep. 2008, and which is fully incorporated herein by reference.

### TECHNICAL FIELD OF THE INVENTION

The present invention relates to computerized training systems for training persons who operate facilities having underground storage tanks, and more particularly, to a computerized facility specific training system such as for training Class C operators as required under the Energy Policy Act 2005 and its attendant regulations.

### BACKGROUND OF THE INVENTION

Currently, a large number of facilities exist that employ underground storage tanks (USTs) to store liquids. The most common example of underground storage tank-containing facilities are vehicle fuel stations wherein fuel is stored in an underground storage tank. Typically, the fuel from the underground storage tank is pumped by pumps to a vehicle fuel tank, such as an automobile gas tank, truck fuel tank, and the like.

Underground storage tank (“UST”) facilities pose potential safety and environmental hazards. Underground storage tanks can create environmental hazards through the leakage of fuel from the tank or pump, the spilling of fuel from the pump or the vehicle fuel tank, or the rupturing of fuel lines that cause a fuel spill and/or possibly, the rupturing of an underground tank. Because of the flammable nature of most fuels, a spill from a UST poses a safety hazzard. For example, a cigarette being smoked while pumping fuel can ignite the fuel and cause a fire and/or an explosion.

Because of these safety and environmental concerns, it is important that persons who operate UST facilities be trained in how to handle both environmental and safety emergencies. To this end, the Federal Government, pursuant to the Energy Policy Act of 2005, enacted regulations that require that operators of underground storage tank facilities (“UST Facilities”) be trained and certified.

One aspect of these regulations is that the operators are required to undergo training, and pass a test in order to achieve certification. A second aspect of these regulations is that each facility must contain one certified operator on duty at the facility at all times that the facility is open. As such, the facility must have enough certified operators so that they will have adequate personnel to man the facility during all business hours. Many underground storage tank facility-type gas stations have a small number of employees, and are often manned by one employee during slower shifts. As such, many facilities will likely be required to certify all of their personnel to ensure that the facility always has someone at the station who is certified.

Another aspect of these regulations is that the training must be site specific. As such, an operator can not undergo generalized training in generalized subject matter. Rather, an operator's training must provide information relevant to that particular UST facility for which the operator-trainee is being trained. This particular facility for which the operator-trainee is being trained will be referred to herein as the “designated facility.” For example, the regulation requires that an operator know the location of the emergency stop button (E-stop) for his designated facility. As the location of the “E-Stop” will vary from site to site, the training for each operator must be specific for the particular site at which she works.

The site specific nature of the required training presents a burden for a company that operates a large number of sites. For example, if a company operates 20 sites, they will likely need to purchase or prepare twenty different training programs, with one training program being specific to each of the twenty sites. This makes developing an adequate training program more complex, more burdensome, and probably more expensive.

The typically high rate of employee turnover at UST facilities compounds the difficulty of ensuring adequate training for all employees. Because of the low wages paid to employees of UST facilities, employee turnover is usually quite high, and having been estimated to average about 280% per year. Because of this constant turnover, training must be on-going for new employees as they begin work at a facility. Additionally, the training must be on a year-round basis since new employees begin their employment all the time. Further, this high turnover requires that the training be performed in a cost-effective manner, so as to not unduly increase the cost of hiring an employee, since part of the cost of hiring the employee is the training cost that is required under the regulations.

Therefore, one object of the present invention is to provide a training system that has the potential to provide a company with a viable, and reasonably economical basis for providing site-specific training to Class C operators in order to ensure that the company can provide training for its operators to cover its facilities, and to otherwise comply with the current legal requirements.

### SUMMARY OF THE INVENTION

In accordance with the present invention, training system software is operable on a digital computer for providing training to operator trainees of underground storage tank containing facilities. The software is capable of delivering facility specific training materials specifically applicable to an operator-trainee's designated facility. The software includes generic content component training materials for providing training applicable to a plurality of facilities including the operator trainee's designated facility. The software also includes at least two sets of regional content component training materials. Each of the at least two sets provide training applicable to at least two, but less than the plurality of facilities to which the generic content component is applicable; and at least one of the sets includes regional content material applicable to the designated facility of the operator-trainee. Additionally, the software includes at least four sets of facility specific component training materials. Each of the at least four sets includes facility specific content material applicable to a single facility, and one of the at least four sets includes facility specific content material applicable to the operator trainee's designated facility.

One feature of the present invention is that it provides a site-specific training system, that enables a company to conduct a training program for its employees that is site-specific to the operator-trainee's designated facility, to enable the employees to gain a site-specific certification, as currently required. This feature has the advantage of enabling the company to train its employees at a reasonably low cost, while complying with the legal requirements that the employees' training and certification be site-specific to the designated facility at which the employee is working.

Another feature of the present invention is that the system is designed to be accessed by a plurality of parties interested in the training and certification. These interested parties include the company that hires the employee, the facility manager who is supervising the employee trainee, and the regulator, such as a state environmental bureau official, who is charged with enforcing the law, and ensuring that companies and facilities under his jurisdiction are in compliance with the law, and have a certified operator at each site at all times.

These and other features and advantages of the present invention will become apparent to those skilled in the art, upon a review of the drawings and detailed description presented below, which set forth the best mode of practicing the invention perceived presently by the Applicants.

### BRIEF DESCRIPTION OF THE DRAWINGS

FIG. 1 is a schematic view, illustrating the various parties who will interface with the training package software of the present invention;

FIG. 2 is a schematic representation of the content of a facility-specific training package of the present invention;

FIG. 3 is a schematic representation of the content of a company package containing a plurality of facility packages for a multi-facility (multi-location) company;

FIG. 4 is a schematic representation of the various communication pathways between various components of the system and package;

FIG. 5 is a schematic representation of the contents of a facility package of the present invention;

FIG. 6 is a schematic representation of a particular module of the facility package shown in FIG. 5;

FIG. 7 is a flow chart representation of the process by which a trainee employs the training system package of the present invention;

FIG. 8 is a schematic representation showing the various components of the server resident package manager of the present invention; and

FIG. 9 is a schematic representation of the process for the field maintenance application component of the training package of the present invention.

### DETAILED DESCRIPTION OF THE PREFERRED EMBODIMENT

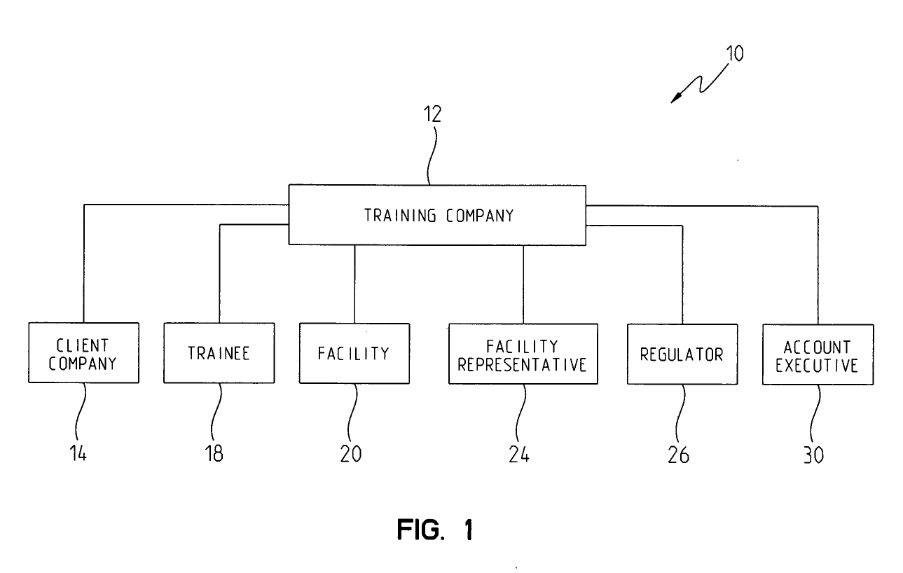

In order to understand the manner in which the present invention operates, it is first important to be introduced to the various parties involved in the training process, and their roles within the process. A representation of the various parties involved in the process is shown in FIG. 1.

At the head of the chart 10 is a training company 12, which is the party who is in communication with all of the other parties. The training company 12 is the company that operates and/or develops the software package, organizes the training, and maintains the server, and the various server functions. Of course, there is no requirement that the training company be a third party, and not done in-house by the client company 14.

Additionally, the training company 12 is likely the company that controls the sales force that obtains customers, employs the software programmers to develop various server applications to serve the program and its participants. Preferably, the training company also employs legal compliance experts familiar with the rules and regulations governing the training, to ensure that the training process complies with the requisite legal requirements, and provides appropriate training to the trainees to place them in compliance with the regulations.

The client company 14 is in communication with the training company 12. A typical client company 14 is a company that operates one or more UST facilities. For example, the client company 14 may comprise a large oil company, such as Exxon® or Shell® that operates a large number of service stations throughout the country. Alternately, the client company 14 may be a local or regional provider of gasoline, such as Pilot, Flying J, or

GASAMERICA®. Additionally, the client company 14 may be a jobber or franchisee who operates a plurality of franchised stations.

Alternately, the client company 41 can be a company such as UPS that operates a large number of UST facilities that solely serve the particular company's own fleet of vehicles. Client companies can also include companies such as rental car companies that operate a plurality of fuel dispensing locations; and retail stores, such as Sam's Club® and Kroger®, that operate fuel dispensing facilities, as an adjunct to retail facilities. Client companies can also comprise a company that operates a single facility.

The next party of interest shown in the chart 10 is a trainee 18. The trainee 18 is the human being who is being trained as a Class C operator in the most preferred embodiment of the present invention, and who will go through the training process and ultimately be certified. In most cases, the trainee is an employee of the client company 14. It is envisioned that most client companies 14 will have a large number of trainees 18.

A service station facility 20 (which contrary to its name) typically now consists of a convenience store with gas pumps and no car repair or service capabilities. Service stations typically have between about eight and twenty employees. A 280% turnover suggests that an average facility may need to train over 25 persons per year. Additionally, as the current requirements are that each person be re-certified every year, it is likely that a typical facility 20 will need to train 25 or more persons per year, every year, given the annual nature of the certification, and the estimated 280% turnover rate.

It is important that the training program be well-suited to the trainees being trained. The service station industry is characterized generally by providing low wages to most of the clerk and counter personnel. Because of the low wages typically paid, it is normal for most service station employees not to be highly educated. As such, the training provided by the system must be designed to be easily grasped and well understood by those who are not necessarily well practiced at the art of studying and scholarship.

The facility 20 is the next party of interest since current regulations require that the training be facility 20 specific. By being facility 20 specific, it is meant that the system must take into account the particular features and item locations of the specific facility 20. As will be appreciated, the locations of certain items, such as emergency stops, communication systems to call emergency personnel, and the like, will differ from facility to facility 20. Because of these differences, the training system must be especially adapted for each facility 20, and in particular, each operator trainee's own designated facility.

The next person indicated in the chart 10 of FIG. 1 is the facility representative 24, who is the liaison between the training company 12, and the particular facility 20. Since the training must be facility 20 specific, information must be gathered about the facility 20 and entered into the training system program, so that the material presented to the trainee 18 will be facility-specific to his designated facility. Facility-specific information includes such things as the number and location of emergency shut off valves, the positions of hoses, the locations at which emergency clean up materials, such as “kitty litter” for absorbing oil spills is contained, the positions of fire extinguishers, etc.

As many facilities 20 are built using a common architectural plan, it is likely that certain information will be consistent among facilities, and especially those facilities operated by a common owner. However, much information will differ from facility to facility. It is the duty of the facility representative 24 to obtain this information about each particular facility 20, and to upload it to the master training program, so that a facility-specific program can be produced. This information includes not only textual information, but also graphical information. For example, information relating to the location of an emergency stop should include not only a textual description of the location of the emergency stop (e.g. under the cash register), but should also include a picture of the emergency stop so that the trainee will be better prepared to visually recognize the emergency stop.

The next person of interest in Chart 10 is the regulator 26. In most cases, the regulator 26 is an employee of the state environmental or petroleum station oversight agency that is charged with enforcing the provisions of the Energy Policy Act of 2005. Under the federal scheme envisioned by the Act, the regulations and overall guidance of the act is governed by the Federal Environmental Protection Agency. However, the various states are charged with the enforcement of the Act, and actually hire the personnel who comprise the regulators. In most states, it is expected that the regulatory body will be the state's environmental agency. For example, in Indiana, it is expected that the state environmental agency, the Indiana Department of Environmental Management (IDEM), will be charged with the enforcement of the Act.

Other states may choose non-environmental agencies to enforce these provisions, such as the fire marshall.

A final person involved in the training process is the account executive 30. The term account executive 30 is the designator used in this application to denote the person who is the primary contact between the training company 12 and the client company 14. The account executive 30 is the person charged with working with the client company 14 to help set up the client company 14 up on the training company's 12 system, and who will likely be the first responder to complaints, questions and other issues raised by the client company 14 with respect to the training program.

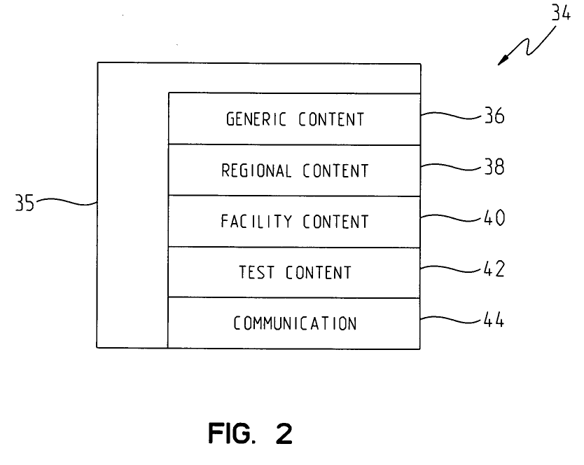

Turning now to FIG. 2, the content of a typical facility package 34 will be explained. A typical facility package 34 includes several different types of information. It should be understood that the various content components or material, such as the generic content 36, regional content 38, facility content 40, test content 42 and communication package 44 represent both data collections, such as information and test questions, and also represent “functionalities” of the system, as the system of the present invention includes not just those collections of data represented by the modules, 36, 38, 40, 42 and 44, but also programming materials that create the educational program by integrating the content from the modules 36, 38, 40, 42 and 44 into an interactive training and testing package useable to educate and certify employees.

The content and communication packages 36, 38, 40, 42 and 44 of the facilities package 34 preferably comprises software that is loaded onto a computer platform 35. Computer platform 35 can comprise a computer 38 at either the gas station facility 18 or a separate training facility. Alternately, the computer 35 that contains the content can be a web server in situations where the company prefers to make the training system a web-based application. Also, the computer 35 can be the control server 50.

Each facility package 34 includes a certain amount of generic content 36. Generic content 36 is the term used in this application to denote, information and training materials that are applicable to a plurality of facilities, and preferably most, if not all petroleum dispensing facilities. The generic content 36 includes such things as general safety information, general flammability information, information about likely outcomes caused by a user smoking while pumping gasoline, and the dangers of leaving a gas pump unattended by a customer filling his tank. Generic content 36 also includes such things as legal regulations and the types of hazardous activities that would be universally applicable to all facilities.

Additionally, each facility package 34 includes “regional content” 38. Regional content 38 is the term used to denote content that, while not applicable to all situations, may be applicable to at least two facilities, but is distinguishable from generic content as regional content is not as applicable to as many facilities as generic content. For example, one type of regional content 38 is content that is specific for a particular state. For example, if company X ran facilities in both Indiana and Ohio, all of the Indiana facilities might include “regional content” 38 that address the peculiarities of Indiana regulations, which regional content would be different than the content 38 particular to the facilities in Ohio. The facilities in Ohio would likely receive “regional content” 38 that was specifically related to Ohio peculiarities.

Additionally, the regional content 38 may include content that is facility related, but that is applicable to a variety of facilities or a class of facilities. As discussed above, branding and cost consideration often dictate that a particular company use a single set of architectural plans to construct a large number of facilities. From a trademark standpoint, the similar construction of a large number of facilities helps to establish the building appearance as a “brand”, and as an identifier of the particular company. In order to save costs in constructing the facilities, it might be expected that these facilities would be constructed similarly. As such, it might be expected that a significant percentage, but not all of a particular company's facilities would be generally similar. Although these “single common plan” facilities might not be completely identical, they may all have their cash registers placed in the same position, and their E-stop switches all placed in a similar position. As such, regional content 38 should be created that shows the position of the cash register and the E-stop. This regional content 30 is useable not only with a single facility, but with all of the hypothetical 30 generally identical facilities. Additionally, regional content 38 can be created to cover a certain class of facilities that have common features. For example, a particular set of regional content 38 may be established for stations with only a convenience store attached, whereas a different set established for facilities containing a fast food outlet.

A third component of a facility package comprises facility specific materials 40. Facility specific materials (“facility content 40”) include such things as the locations of various safety items, along with such things as procedures that might be specific to a particular facility. Since the regulations require that the trainee be trained with a facility-specific package, it is likely that each facility's content 40 will be slightly different, as each facility is slightly different.

A fourth component of a facility package 34 is the test content 42. After a user is presented with his training material, the user is tested over the material. The testing of the user is done both because it is necessary in order for the user to be certified, and also because it helps to ensure that the user in fact, learned the material he was taught.

In order to ensure the integrity of the process, the test content 42 is designed to be randomized. As such, not every trainee at a facility will be given the same test questions. In order to ensure the integrity of the process, the test content 42 should be kept someplace other than on the facility's computer, such as being kept resident on a remote server.

The next component of the facility package 34 is a communication package 44. The test content 42 and test results of a particular training session are communicated by communication module 44 between the computer on which the training is being conducted, and the server. Through this communication, the centralized “system wide database” on the host server will know that the training has occurred, and that the trainee has completed a particular module, or a complete package and either successfully passed or failed go pass. The ultimate aim of this communication is to provide the system wide database with the information necessary to enable the system and/or system operator to have up to date information of the status of each trainee in the system.

This status includes a trainee status level of “certificable”, so that the system and/or system administrator, and/or training administrators (e.g. client company 14, facility representative 24, and/or regulator 26) will be able to learn and determine that a particular trainee(s) has completed all of her training requirements and is eligible for certification. Depending upon the desires of the users, the certification can be either automatically granted by the system 34, or may be designed to include a step wherein the certification is validated and/or approved by human intervention prior to granting.

The facility package shown in FIG. 2 can be delivered through several different media. One way to deliver the package is to provide a facility with a plurality of discs that contain the facility package. These discs can be inserted on to a computer 35 at the facility 20, so that the trainee can undergo his training at the facility 20 by using the facility's computer 35. Alternately, the discs may be given to the trainee, so that the trainee can load it on a computer to which she has access either at home, school or a library.

In the situations described above, it is envisioned that the generic content, regional content, facility content and communications software will be contained within the discs that are downloaded onto the trainee's computer 35. However, the test content will likely be maintained on the server 50 itself.

Another alternative is to maintain the material upon the central server 50, or on a web server, and allow it to be downloaded by the user, or otherwise enable the trainee to be taken on line through the use of web based, non-downloadable software. Once again, when designing the program and its methods of use, it is important to be mindful of the population being trained, to ensure that the training package is efficient and easy to use for such trainees.

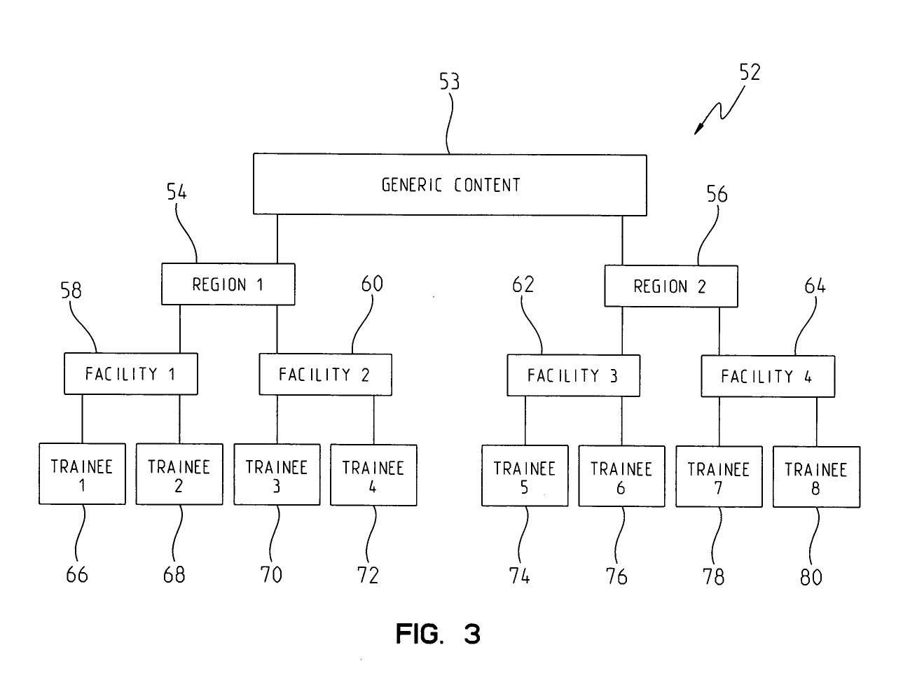

Turning now to FIG. 3, the contents of a typical company software package 52 is shown schematically that is designed for use by a client company 14 having a plurality of facilties 58, 60, 62, 64 and regions 54, 56. The company software training package 52 includes generic content 53 that is likely similar to the generic content in a particular facility package 34 discussed in connection with FIG. 2. Additionally, the company package 52 may include one or more regional content packages 54, 56. For example, to the extent that the regional content relates to state regulatory peculiarities, the hypothetical company discussed above that operates in Indiana and Ohio might include two different sets of regional content (Region I package 54 and Region II package 56), that relate respectively to Indiana 54, and Ohio 56 peculiarities.

Further, the company package 52 includes a plurality of facility specific content packages 58, 60, 62, 64, the number of which would likely correspond to the number of facilities that are operated by the company 14. In FIG. 3, four facility packages 58, 60, 62, 64 for use with four facilities are shown as being illustrative.

Further, the content of the company package 52 includes content that is trainee specific, and that differs from trainee to trainee at each facility. As shown in the drawing, two students 66, 68 are shown as being certified at facility 1 (58), along with two students 70, 72 being shown as being certified at facility 2 (60); two students 74, 76 are trained at facility 3 (62); and two students 78, 80 are shown at facility 4 (64). The trainee specific information includes information such as whether the particular students 66-80 had been certified, their dates of certification and other materials germane to those particular students (name, address, employee number, etc.). This information may be contained within the client company's 14 computer, or may be contained on the facilities computer operated by the training company 12. In any event, the client company 14 should have access to student information, so that it may determine which of its employees were trained and certified, and also determine the status of any particular employees at any particular facility, so that the client company 14 may assure itself that it has a sufficient amount of trained operators at each facility 58, 60, 62, 64 so that each facility can conduct business in compliance with the requirement that at least one certified operator be on site at all times.

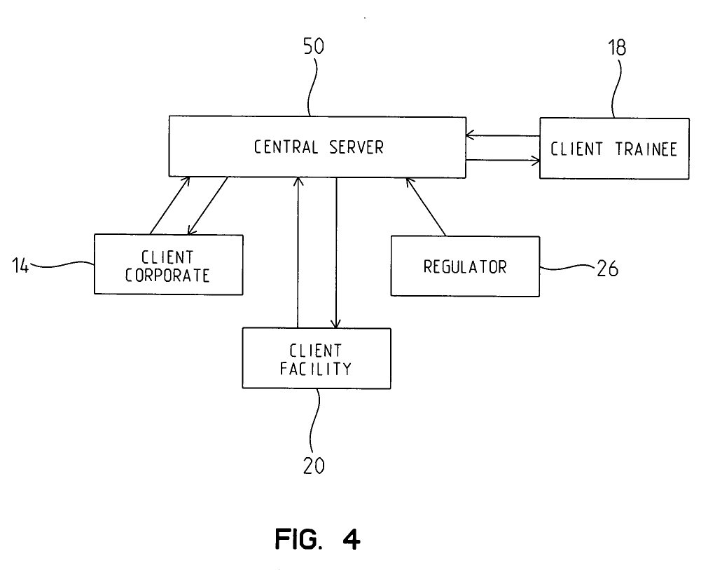

FIG. 4 illustrates the various communication interactions between parties involved in their training process. In FIG. 4, only the “customer” 14, 18, 20 and “regulator” 26 components are shown, with various training company management and training company directed personnel, such as client representatives being excluded. As shown in FIG. 4, most of the information relevant to the training program is resident on the central server 50. Although individual training packages may be downloaded and placed on individual computers used by individual trainees 18, the results of the testing, the certification information and the like, will generally be kept on the central server 50, along with such things as test results.

The central server 50 communicates with client corporate personnel 14 on a regular basis. Communication between the server 50 and the client corporate personnel 14 includes information being sent by the central server 50 to the client 14 relating to invoices for the client's personnel trained by the training company 12; and information about the trainees 18, certified for the client company 14. Additionally, information from the central server 50 may be sent to the client 14 that relates to the need to re-certify past trainees who need to be kept current on their once-a-year training requirement.

The client 14 will access the server, to employ the server 50 primarily as a database and a repository of information about the client's 14 employees. For example, the client 14 would be expected to communicate with the central server 50 to gain information about the status of particular employees 18, and the status of particular facilities 20. The client company 14, for example, may wish to determine which of its employees 18 who work at a particular facility 20 are certified. By contacting the central server 50, the client 14 should be able to retrieve this information for use.

Additionally, the client 14 may wish to mine the data on the server 50 to determine facilities 20 at which a particular employee is certified. It is expected that certain employees 18 will be certified at several different facilities 20. These employees 18 will have enhanced value to the employer/client 14 because these employees 18 will be able to serve as “floaters” to fill in for absences at particular facilities 20 or particular needs at particular facilities 20. For example, if a wave of sickness or employee turnover inflicts a particular facility 20, leaving that facility 18 with a significantly reduced number of regular employees 18 capable of working a particular shift, an employee 18 from another facility 20 who is cross-trained at the illness-ridden facility may be transferred for a shift, or for a short interval of time to “cover” at the illness stricken facility.

Communication also occurs between the server 50 and the facility 20. The communication between the server 50 and the facility 20 includes such information as forwarding downloads from tests from the server 50 to the facility; and other software downloads from the server 50 to the facility 20. Additionally, the management of the facility 20 may wish to use the server 50 to determine which of its employees 18 are certified. Such information aids the manager of the facility to schedule his employees 18, to enable the manager to ensure that his employees 18 are scheduled in a manner that ensures that a certified person is on site at the facility 20 at all times.

Communication between the client trainee 18 and the central server 50 will occur during the training process. For example, the client trainee 18 may communicate with the central server to download the training program from the central server 50 onto the client trainee's 18 personal computer. Even if that does not occur, and the client trainee 18 loads the program onto his computer through a CD ROM or a DVD disc, the client trainee 18 will communicate with the central server 50 with regard to the testing component. Further, communication between the client trainee 18 and the central server 50 will be constant during the training process if the training is presented in an interactive on-line format, or streamed from the central server 50 to the trainee 18 in a WEBINAR type format.

Preferably, the test questions are kept resident on the central server 50 where they can be better randomized by the central server 50 for presentation to the trainee. As such, when a client trainee 18 is undergoing training, she will review the training materials for a particular module or “chapter”. After the trainee 18 completes her review of the materials for a particular chapter, she will then take the test. To take the test, she will download questions from the central server 50, and upload her answers to the central server 50. Through this process, the central server 50 will be able to feed questions to the client trainee 18, “grade” the client trainee's 18 responses, and determine whether the trainee 18 has accumulated sufficient points to have satisfactorily completed a particular session.

At the completion of the training, the client trainee 18 will also communicate with the central server 50 that the training is finished, and the central server 50 will then communicate with the trainee 18 that he has received his certification, or alternately, has completed all of the requirements for certification, and will receive such certification, contingent upon the payment of any monies owed by the corporate client or approval from the training supervisor, and the registration of the certification with the appropriate state agency.

The government authority regulator 26 will also communicate with the client server 50, as the regulator 26 uses the client's server 50 to find information about the employees at a particular facility 20. It is envisioned that a primary use of the central server 50 by a regulator 20 will be during inspections. In this regard, prior to an inspection, the regulator 26 may communicate with the central server 50 to determine which employees at a particular facility 26 are certified. The regulator 26 may then go to visit the client facility 20 to determine which employees are on duty at the facility 20, and more particularly, to determine whether there is a certified employee currently on duty at the facility as required. Additionally, the regulator 26 may tap into the central server 50 to review the certification records of a plurality of facilities operated by the client 14, to ensure that each of the client's facilities 20 have an adequate number of trained personnel. For example, if the regulator 26 were to review the certified operators at a particular facility 20, and believe that facility 20 to be inadequately served, the regulator 26 may then choose that facility 20 for a personnel site inspection. By previously determining the number of certified operators at that facility 20, the regulator 26 can better choose which facilities 20 are likely to be out of compliance, and hence, which facilities 20 are most deserving of the regulator's 26 valuable time to inspect personally.

Further, the regulator 26 may wish to review the number of persons who are certified at a particular facility 20, to determine whether the number of people 18 being trained is in line with the number of trainees 18 that one would expect to be trained given the norms of turnover and facility 20 size. The regulator 26 use the numbers of certified persons at particular facilities as a vehicle also to determine which (if any) facilities 20 are most likely to not be in compliance, and therefore justify a personal inspection visit.

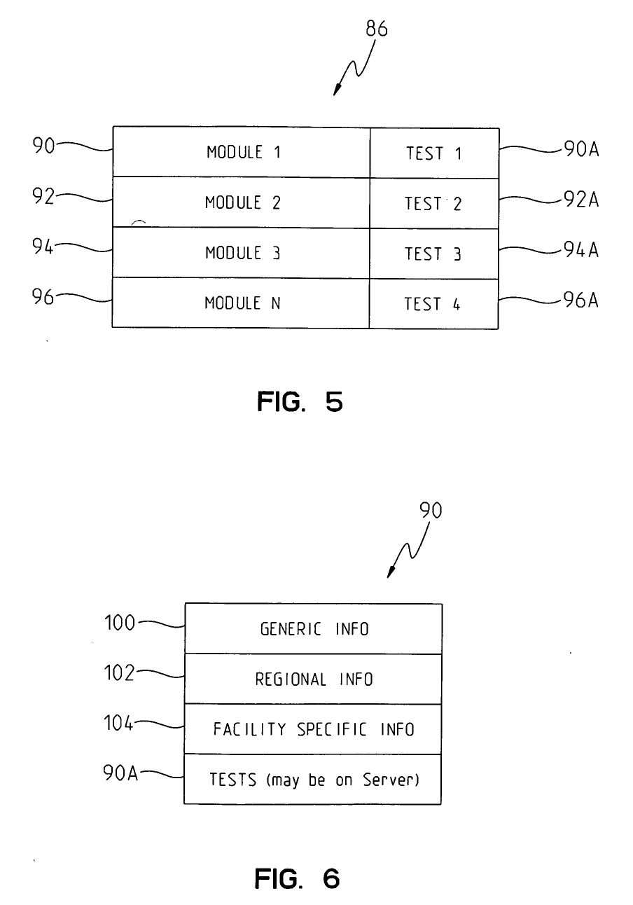

FIG. 5 schematically illustrates the contents of a training package 86 from a module perspective. It will be noted that a training package 86 consists of several modules, here shown as Module 1 (90), Module 2 (92), Module 3 (94) and Module N (96). The modules 90, 92, 94, 96 are each functionally similar to a chapter of a book or a single subject matter interactive training sesson, and most likely will be organized along content lines. For example, Module 1 (90) might related to recognizing hazardous situations and include training to enable the trainee 18 to recognize potentially hazardous situations, such as a customer smoking a cigarette while pumping gas into their tank; a user leaving a gas pump unattended while dispensing gas so that the user can shop in the store; or a user talking on his cell phone while pumping gas and thus increasing the potential for a stray static charge.

In contrast, Module 2 (92) might relate to a different topic such as how to operate an energy shut off, and how to handle spills; and Module 3 (94) may deal with another topic, such as handling drive off situations wherein the customer drives off with the gas nozzle still in the tank, and thereby disengages the nozzle and/or hose from the pump. Module N (96) is shown to designate the plurality of other potential subject matter areas wherein training could be rendered, including those subject matter areas necessary for certification, and those subject matter areas that the company may wish to add that do not necessarily relate to certification. Examples of such areas include topics such as cash register training, diversity training and training on how to deal with a robbery situation.

It is envisioned that the user will go through each module 90, 92, 94, 96 individually and sequentially. While going through a module, the user will first be given instructional materials to teach him about the particular topic. After receiving instructional materials, the user will then be tested on the particular module 90, 92, 94, 96 by taking tests 90A, 92A, 94A and 96A. As discussed above, during the testing period portion 90A, 92A, 94A and 96A, the user will usually be asked to connect his terminal or computer to the Internet, so that the test questions can be downloaded from the central server 50 on to the trainee's device.

Preferably, the test is designed to not allow the user to proceed onward to subsequent modules without first completing a particular module. Nonetheless, the test is also preferably designed so that the user can choose the order in which he reviews the modules 90, 92, 94, 96 and is tested thereon. Although the modules 90, 92, 94, 96 are shown as Module 1, 2, 3, N, the user may choose to review the modules in the order of Module 2, N, 1 and then 3, 92, 96, 90, 94. The important thing is that the user will not fully complete all of the requirements for certification until all of the modules 90, 92, 94, 96 are completed, along with the tests therefore.

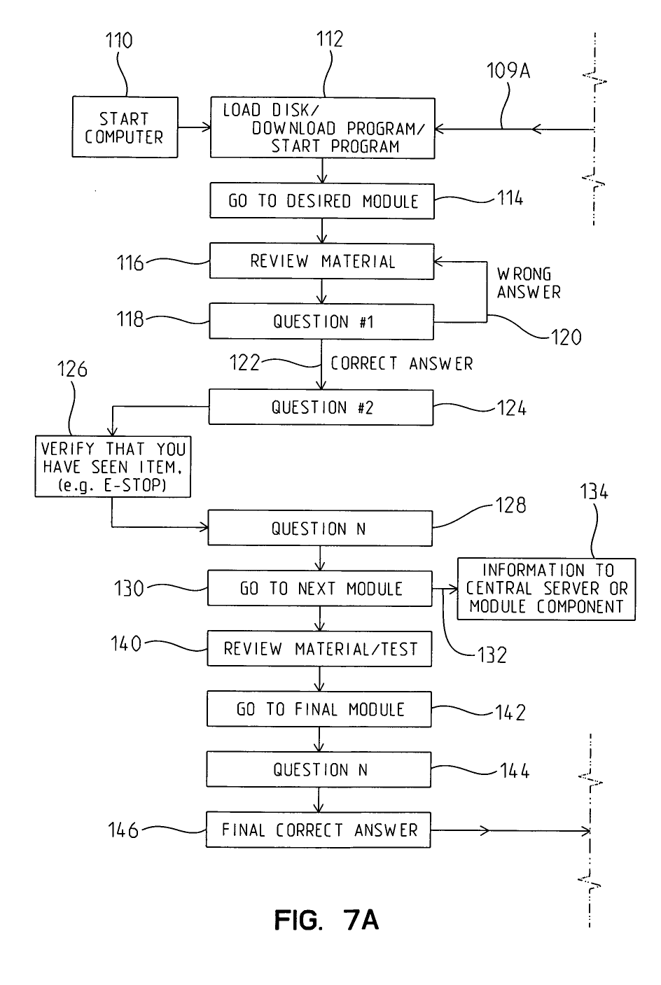

FIG. 6 schematically displays the contents of a particular module. The exemplary module (here, module 1, 90) will include generic information 100, about a particular subject matter of the module 90. It is envisioned that generic subject matter 100 will exist, that will be applicable to all facilities. Additionally, each module 90 may or may not include regional material 102 that applies to a plurality of facilities, but not all facilities. Finally, the module 90 is likely to contain facility-specific material 104. These generic 100, regional 102 and facility-specific 104 materials will all likely be integrated into an organized and coherent package. For example, in a module 90 dealing with the emergency shut-off procedures (e.g. in the case of a fire or spill), there may be generic material 100 that discusses how spills occur, such as by overfilling a tank, or a drive off that tears a hose from a pump, how to recognize such a spill, and what steps need to be taken in case of such a spill, such as by engaging the emergency shut-off switch for either the particular pump, or the emergency shut-off for the station.

Regional information 102 can then be incorporated that discusses Indiana's particular regulatory requirements, or the company's particular procedures. For example, Indiana's regulatory requirements may require a station operator to notify the Indiana Department of Environmental Management in the event of a spill. Additionally, the particular client company's policies may require that a particular designated employee be notified if a spill occurs or the local fire department Hazardous Materials Response Team (HAZMAT). Finally, the particular module can include facility specific training material such as information 104 relating to the location of the particular emergency materials at that particular facility, thereby integrating the facility specific materials 104 into the training program.

Finally, the module includes tests 90A. As discussed above, the test materials 90 may be part of the material that is downloaded from the server 50 onto the personal computer when the training materials are downloaded, or otherwise, may be materials that are resident on the central server 50, and that are accessed by the user 18. The choice of location for the test materials 90 involves a balance of maintaining test integrity, (that favors maintaining the material on the central server 50) versus considerations of Internet access (which may not always be available to the user), that would tend to suggest that the test materials 90A should be downloaded onto the trainee's computer 18.

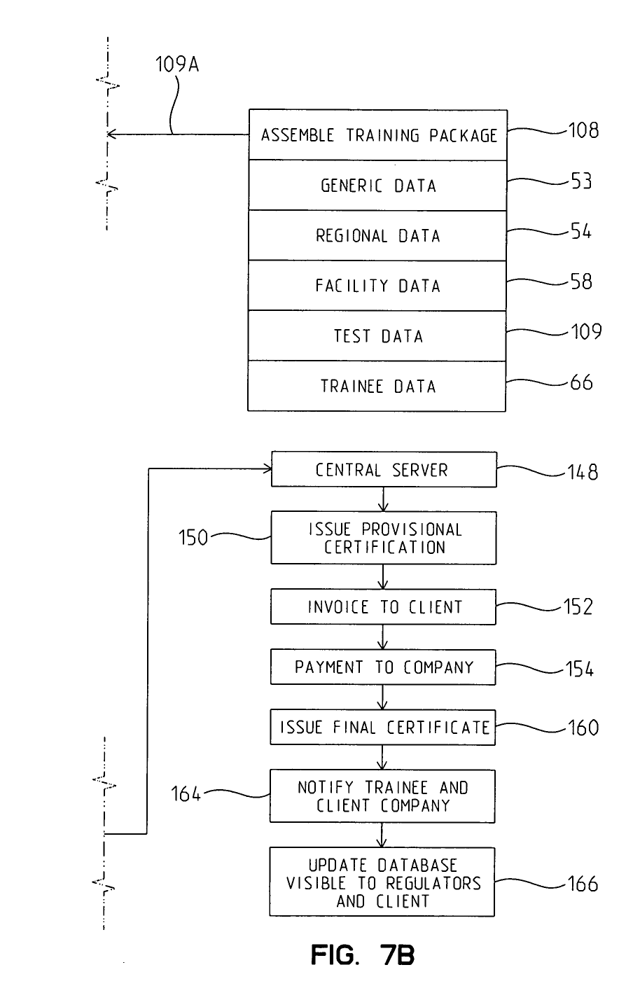

The reader's attention is now directed to FIG. 7, wherein the training regime used with the computerized system of the present invention is disclosed in flow chart form and is described in more detail.

In order to begin the training, the first steps is to assemble the training package 108 for the particular trainee. Assembling the training package requires the assembly of the generic data (e.g. 53), regional data (e.g. 54), facility data (e.g. 58), tet data (e.g. 109) and trainee data (e.g. 66) that is appropriate for the particular trainee and the particular facility at which he is being trained. This assembled data may then be downloaded on to a disk 109 for the trainee to install on his computer; or else may be downloaded through the Internet onto the trainee's computer. The user begins his training by starting his computer 110. This step is followed by the program assembled training package 108 being loaded onto the trainee's computer at step 112. The training package 108 can be loaded onto the trainee's computer at step 112 either through a data disc, such as an optical or magnetic disc; a flash drive, a thumb drive, or some other storage mechanism, that contains the program, and that can transfer the program from the data storage means onto the computer.

Alternately, the program can be downloaded from a web site connected to the central server 50; or the entire program can be resident on the web site. However, it is believed that the training system would be more efficient if the bulk of the program is downloaded onto the trainee's individual computer, as this frees the trainee from slow Internet data transfer rates, and Internet interruptions.

Once the program is downloaded, it must be started at step 112. When the program is brought up on the screen, it is likely to first contain an information screen drawn from the trainee data 66 portion of the package wherein the trainee will complete certain information about herself, such as name, address, and other information desired by either the training company or the employer.

Once this is completed, the user will likely go to the menu screen. The menu screen preferably contains a listing of the various modules that are available to the user. Additionally, the menu screen may include an “Introduction Module”, that is provided primarily for providing training in the operation of the program 108, rather than training in the operation of an underground storage tank containing facility.

It is envisioned by the Applicants that the user will have the ability to select the order in which he reviews the modules. As such, if seven modules exist, the user may decide to review them by starting with the sixth module, and then moving onto the second module, followed by the first module, etc., as opposed to reviewing the modules in a numerically progressive sequence.

After the user selects the module that she desires to review, the user then goes to the desired module 114, and the module is “opened up” on the user's computer screen. Opening the module and “playing the module” will present the user with educational material that relates to the subject matter of the particular module. This subject matter may include textual material, graphic material, photographs, audio material and/or visual material. The purpose of this educational material is to teach the subject matter of the module to the particular user by permitting the user to review the material 116 and be tested over the material 118.

After the user has reviewed all of the educational material 116 within the module, she is then tested over the module material. If the test questions are kept resident on the training company's central server 50, the user at this point will need to connect his computer to the Internet to gain access to the questions. However, if the questions are downloaded onto and kept resident on the trainee's computer, the trainee will not need to make this Internet connection.

A possibility exists that server resident test question versions will be offered along with trainee computer resident test question versions. The advantage of maintaining the test questions on the server, is that the questions are likely to be kept more secure, and can be better randomized. Additionally, the test will likely have a higher degree of integrity if the test questions are kept on the server, as it will be more difficult to “cheat”. However, the drawback of keeping the test questions resident on the server is that to do so requires the user to have reasonably easy access to the Internet. For some users, this may not be possible, thereby making the test highly inconvenient for the user. For such users, the client company may opt to use versions of the training program wherein the test questions are kept on the trainee's computer.

A series of questions 118-124, 128 will be presented in the test section. If the trainee answers a particular question correctly 122, he will then progress to another question 124. However, if the trainee answers the question incorrectly, the program will then reroute him via return loop 120 back to the particular portion of the review materials 116 that covered the subject matter of the question 118. This will enable the user to re-review the material 116. After the trainee re-reviews the material at step 116, he will then presented with a question at step 118 that covers subject matter similar to that covered by the incorrectly answered question and covered by the re-reviewed material 116. Although the question will cover similar subject matter, the question will preferably be different. For example, the question may be phrased differently, or may cover a different aspect of the materials 116 so as to reward the user for paying attention to the re-reviewed material 116 or alternately, to decrease the likelihood that a trainee who fails to re-review the material will answer the question correctly.

Assuming that the trainee answers the question correctly on the second go-around, the training will then progress to a second question 124.

One option that the program has is to require the trainee to verify information at step 126. For example, question #2 may ask the user about the location of an emergency stop button. After answering the question, the program may wish to verify that the trainee has actually seen the emergency stop button. To do so, the program will then instruct the trainee at step 126 to actually go look at the item and the ask him a question that he would only be able to answer correctly if he had in fact, seen the item.

Since the program contains localized content, this verification could be done quite easily. For example, in the verification step 126, the program may ask the user to go find the emergency stop button, and then verify that the trainee has found it by asking the trainee to name the color of the paint adjacent to the emergency stop button. By being able to correctly answer this question, the trainee will then verify that he has in fact, seen the actual emergency stop button. This verification will better help to ensure that the trainee does indeed know where the emergency stop button is located, and will also increase the likelihood that the trainee will remember the location of the emergency stop button in case an emergency situation arises that requires the user to actuate the emergency stop button.

After the trainee has successfully completed all of the questions presented relating to the module being reviewed by correctly answering question N 128, the final question of the module, the trainee will then be directed back to the menu screen. At the menu screen, the trainee can choose the next module he wishes to review. Concurrently, information will be sent by path 132 to the training company's central computer 134 that records that the particular trainee has successfully passed the just-completed module.

The trainee will then continue on to subsequent modules 130 where he will review the information and be tested on it at step 140, until such time as the trainee reaches the final module 142, and has provided the final correct answer 146 to the final question 144 of the final module 142. After the trainee has reviewed the material in the last module, he will then be presented with a series of test questions for the final module that will terminate in the last question 144, which is designated in the chart as “Question N”. Assuming that the trainee answers Question N 144 correctly, information about his completion of the training course will then be forwarded on to the central server 50.

Since information relating to the passage of the other modules should already be contained on the central server at step 134, the information about the passage of the final module, and hence, the completion of the training course will be added to the central server module 148. When the central server module records that the trainee has completed 15 step 148, the central server 50 will then be programmed to issue a provisional certification 150, that indicates that the particular trainee has completed the training. As discussed above, it may be desirable to insert some human intervention into the process to ensure that the issuance of a provisional certification at step 150 is proper and appropriate.

Concurrently with the issuance of the provisional certification 150, an invoice will be forwarded to the client company at step 152 for payment. Once payment from the client company is received 15 step 154 by the training company, the central server will issue a final certification at step 160 for the particular trainee. This final certification 100 will then be forwarded at step 164 to the client customer and the trainee. Concurrently, the data base of certified “operators” will be updated at step 166, so that company officials and regulatory officials who have access to the system can determine that in fact, the particular trainee is indeed certified.

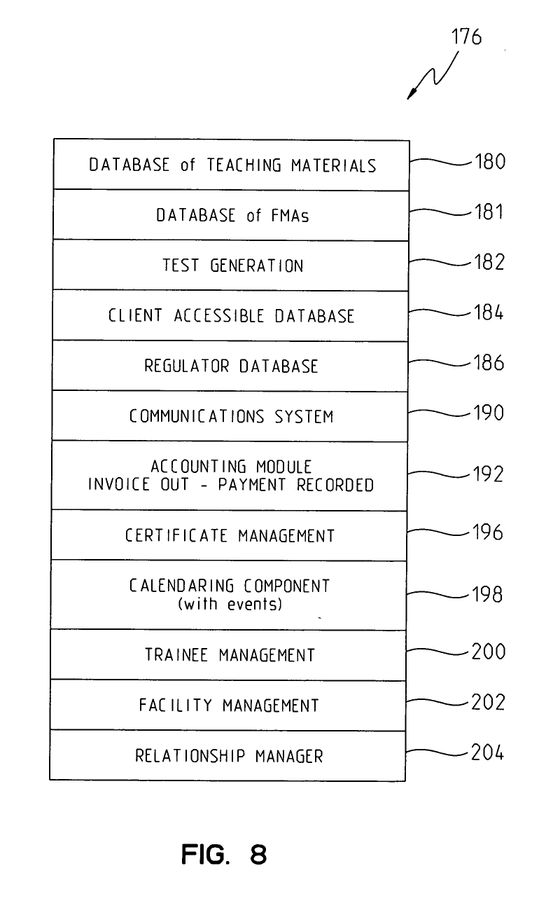

Turning now to FIG. 8, a schematic representation of the contents of the training package materials of the entire system 176 of the server are shown. This diagrammatic representation is useful in that it helps to describe the various aspects of the program and helps to depict the training package 176 as a whole including all of its generic, regional and facility-specific content.

In the schematic representation of FIG. 8, the various data sets are shown as being compartmentalized in different areas. This may not necessarily be the case. Rather, it should be understood that FIG. 8 discloses the presences of various “content areas” to help the reader better understand the types of contents that are contained on the central server and which make up the global system package 176. It will be appreciated that all this material of the package 176 can be included within a single large database, and that the particular content areas can actually comprise one or more “fields” within a database, and one or more applications within the database for mining or treating the data contained within.

In the discussion hereunder, the various areas will be referred to as components to reflect that the areas comprise not just databases of data, but also application functionality. For example, as database of teaching materials component 180 includes not only data and materials used for teaching, but also includes, inter alia, the software for assembling the appropriate generic, regional and facility specific materials into a training package that is appropriate for a particular trainee who is being trained at a particular facility.

One component area comprises the teaching materials component 180, that are used in the training program. These teaching materials in component 180 include generic materials, regional materials and facility-specific materials. These database materials in component 180 are organized in a manner so that, when a user decides to download a testing program for a particular facility, the appropriate generic material, regional material and facility-specific material are mated together to form a coherent facility-specific training package.

Another database area contained within the server is the database of “FMAs” component 181. FMAs relate to the Field Maintenance Applications. Within the FMA database component 181 is contained site specific information. For example, one item of site specific information that may be included for a facility is a photograph of the location of the emergency stop button for that particular location. These facility specific items would be maintained within the FMAs database component 181, for integration and mating by the system 176 with appropriate regional and generic materials, when a user or the training company desire to download or produce an integrated training package for a particular facility.

The server also contains a test generation component 182. The test generation component 182 includes various test questions that are useable with the training program, and a randomizing functionality for randomizing questions that are given to trainees, so that the test differs from trainee to trainee, to thereby enhance the integrity of the test. It is envisioned that the test questions will be separated by subject matter area, and randomized within a subject matter area. For example, one subject matter that might be covered could relate to the location of the emergency stop and the manner in which to operate the emergency stop at a particular facility.

The test generator component 182 may contain a large number of questions about the subject matter area, even though only a few questions will be given to any one trainee. Additionally, the test generator component 182 is preferably able to randomize the answers for even the same questions. For example, a test question may be designed as a multiple choice question having potential answers a, b, c, and d. The test generator component 182 should preferably have the capability of “scrambling” the answers so that answer “A” on one trainee's test will be positioned as answer “C” on another trainee's test.

Another portion of the system package 176 contained on the server is a client accessible database component 184. It is envisioned that the training company's database will include information for a large number of trainees, a large number of clients, and a large number of facilities. In order to maintain customer privacy, each particular person who has access to the database will be given access only to that information contained within the database that is appropriate for that person. For example, if Shell and Texaco were customers of the training company, Shell personnel would only have access to a client accessible database component 184 relating to Shell facilities, and Texaco personnel would only have access to Texaco-related facilities.

Depending upon the customer's desires, information about a particular company could also be segregated and separated, so that various persons had access only to that information that pertained to their particular job function. For example, the senior vice-president of a client company who was in charge of training for all facilities of a particular company might have access to company information relating to all the facilities and all the trainees. By contrast, a regional manager who worked under the above described vice president may only be granted access to company information relating to the facilities and trainees within his particular region of responsibility.

It is believed that the primary client accessible database information 184 that a client will wish to obtain on an ongoing, regular basis, is information relating to the certification status of various employees of the client company, and the number of certified operators at any particular location. Additionally, it is likely that client's companies will have a significant interest in certificate expiration dates, so that the client can better ensure that certifications are updated prior to their expiration so that operators remain current. As alluded to above, current regulations require that every operator be certified on a yearly basis. As operators will be trained at random intervals throughout the year, it is believed that certificates will also expire at random intervals. As such, a training manager for a particular company will likely need to keep track of these expiration dates on a year round, ongoing basis to ensure that the personnel are re-trained and re-certified prior to the expiration of their particular certification, as it is likely that these re-certification dates will occur as randomly throughout the year as birthdays and anniversary dates.

Another database component is the regulator database 186. The regulator database 186 comprises that information within the database that is accessible to the regulator and associated functionally to enable access to the regulator. The scope of this information will likely be governed by those regulations that dictate the type and amount of information that must be made available to the regulator, and such other information as is deemed advisable to make available to the regulator. Currently, it is believed that the regulators are likely to be primarily concerned with data information relating to the names of persons certified at particular facilities. For example, it is likely that regulators will employ the system when conducting an inspection at a facility. Prior to inspecting a facility, the regulator may obtain information relating to the names of those parties who are certified at a particular facility. When the regulator then visits the facility, the regulator will determine whether at least one of the persons listed as being certified for the facility is on duty at the time of the visit.

The failure to have a certified person on duty when the regulator visits and inspects the facility will likely be an indication that the particular facility is not in compliance with the regulations, and may result in the facility being fined, and/or shut down for either a determinate period of time as a fine, or for an indeterminate period of time until a certified person does go on duty at the facility.

Preferably, the regulator's access to database information is limited to those facilities and companies within the regulator's jurisdiction. For example, a regulator in Ohio will likely not be granted access to information about a particular company's facilities in Indiana. Even a regulator within a certain geographic area (e.g. Central Indiana) may not be granted access to those facilities that are contained in geographic areas other than that area serviced by the particular regulator unless the regulations under which the regulator operates gives the regulators access to information outside the particular regulator's area of responsibility.

Another aspect of the training company's server is that it will contain a communication systems component 190. The communications system component 190 is designed to grant access to those who desire and are authorized to gain access to the database. Additionally, the communications system 190 will enable those persons, such as trainees who desire to download the program, to access the server and download such programs. Further, the communications systems preferably is designed to enable the trainee to gain access to test questions resident on the server, and to enable the training program to transfer information about the trainee's progress to the server. Also, the communication system 190 will need to be capable of communicating information such as forwarding invoices to customers.

The system package 176 on the server also includes an accounting module component 192. The accounting module 192 performs those functions typically performed by an accounting module, such as sending invoices to customers, and recording payments. As one method of operation is to issue final certificates only upon receipt of payment from the client company, the accounting module will likely need to communicate with the certificate management program component 196, so that the system 176 will issue a certificate, upon receiving a signal from the accounting module 192 that the training has not only been completed successfully, but also has been paid for in full.

The system package 176 on the server also contains a certificate management program 196. The certificate management program component 196 is largely a database related program, that keeps track of all the various certificates issued, and also the persons who have such certificates. Additionally, as the certificates expire yearly, the certificate management component should be designed to keep track of those certificates that are “live”, those certificates that have “expired” and the dates on which particular certificates expire.

The system package 176 also includes a calendering component 198. A calendaring component 198 is designed to help manage renewals. Preferably, the calendaring component 198 keeps track not only of renewals, but also includes a mechanism for sending out reminder notices to either trainees, employers, or both, prior to the renewal date of the trainee's certification. By sending out such notifications, the employer and/or trainee can ensure that the trainee's certification is renewed in advance of the certification expiration date.

Due to the normally high turnover within the petroleum marketing industry, it is likely that the calendaring program 198 will send renewal notices primarily to the client employers. The employers can then match the employees/trainees needing the renewal, with the employees still employed by the client. The client company can then direct those still-employed employees to undergo their renewal training program. In this regard, the calendaring component 198 is preferably designed to communicate with the client company's personnel record, so that the system 176 can help the client determine which employees in need of renewal are still employed by the company.

Preferably, the system package 176 also includes a trainee management function component 200. The trainee management function 200 keeps track of the progress of the trainees, to ensure that they are making progress in completing the training program. For example, the trainee management component 200 of the package 176 may be designed to send a notice to the client company employer if the trainee does not complete his training within a certain predetermined time from the time at which the training begins. This notification may cause the employer to address the failure to complete the training with the particular trainee, or take other disciplinary actions. In other cases, there may be no need for the employer to take any action, as the employee may have quit by the time that the employer receives notice that he has not completed his training within a particular period of time. The notification would thereby provide a signal to the company to remove the trainee from the system.

Another component is the facility management system component 202. Within this component 202, information will be kept relating to specific facilities. Examples of such information includes information about the various employees who are certified at a particular facility. This information may be accessible by the facility manager, so that the facility manager can ensure that he has an adequate number of trained and certified personnel.

Another component of the system package 176 is a relationship manager 204. The relationship manager component 204 enables the training company and client company to interface with each other, to monitor the progress of the other, and to address any issues that might arise between the training company and its customer, the client company.

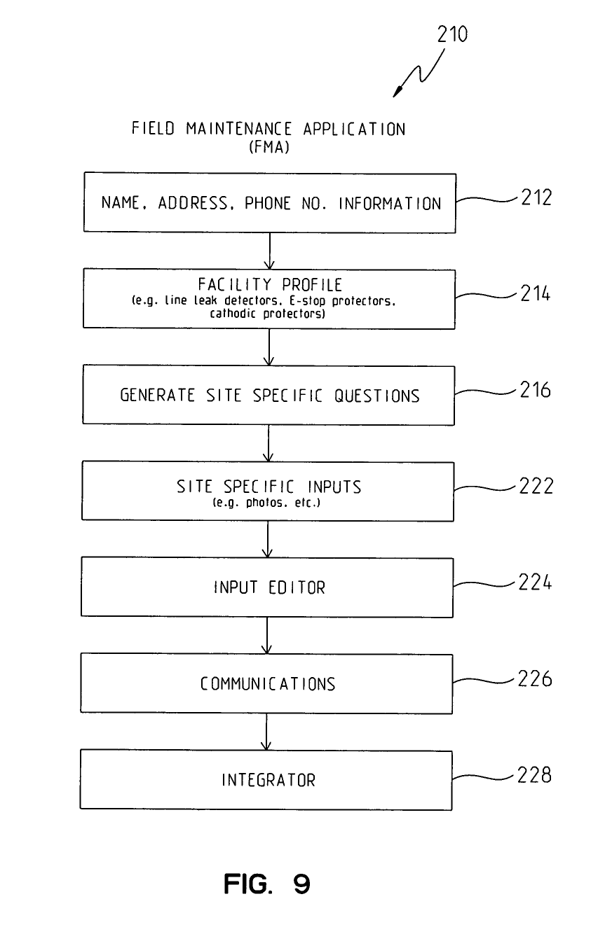

Another unique aspect of the package 176 is the field maintenance application component 210 (FIG. 9). As stated several places above, the training provided by the Applicants' program is site specific. As such, facility specific information must be incorporate into the test materials, to truly make the system site and facility specific. Due to the large number of individual facilities containing underground storage tanks, a large amount of information must be gathered by a training company's personnel (or their designees) from a large number of facilities.

A large number of facilities also requires a large number of “field gatherers” or customer representatives, to acquire this information. Additionally, in order to ensure that the training regime for each facility is complete and appropriate, the material that is gathered relating to and about each facility must be standardized.

Managing a large number of customer representatives and facility information could create a significant management burden. In order to reduce the management time and energy required to manage such a system, the field maintenance application component 181 is created to increase the likelihood that appropriate, standardized information will be obtained from the customer service reps that is of the type that can be easily incorporated into the training program for a particular facility.

As best shown in FIG. 9, the field maintenance application 210 comprises the various steps that the customer representative must go through, in order to incorporate information about a particular facility into the system. The field management information from each facility will become a part of the database of FMA's component 181 of the package 176.

The first set of materials that must be acquired is facility overview information, such as the facility identity and contact information 212 including name of the facility, its address and phone number information.

After this identifying and contact information 212 is entered into the system, the customer representative then gathers information relating to the facility profile 214. Such facility profile information 214 relates to the number of E-Stop devices, the number of live leak detectors, and the number of cathodic protectors, or, possibly, the absence of such cathodic protectors.

From this facility profile 214, the field maintenance application 210 can then generate site specific questions 216, such as questions relating to the location of the E-Stop protectors, and questions relating to the location and operation of the line leak detectors.

The facility maintenance application 210 will then ask the customer service rep to provide site specific inputs 222, such as photographs, diagrams and the like that can be incorporated into the teaching program. For example, a photograph showing the emergency stop could be uploaded into the program, so that when training material is being presented relating to the emergency stop, a photograph will be available of the emergency stop that the trainee can view the E-stop to better help familiarize the trainee with the appearance of the emergency stop and its position within the facility.

An input editor 226 is then provided that helps to take the information 212, 214, 216, 222 about the facility and convert it into a standardized form and format. For example, pictures should be standardized to be a particular size to ensure that the photographs are appropriately sized.

The field maintenance application 210 also includes a communication package 226 that can facilitate communication between the customer representative's computer, on which the facility specific information will be input, and the client's server wherein the facility specific information will be stored.

Finally, the field maintenance application includes an integrator component 228 that will likely be contained on the client's server. The integrator is provided for integrating the facility specific information into the generic and regional information relative to a facility, so that an integrated test can be provided that includes generic, regional and facility specific information that is incorporated in a coherent way within the training program.

Having described the invention with respect to certain preferred embodiments, it will be appreciated that variations and modifications exist within the scope and spirit of the present invention, and that the scope of the invention is to be limited only by the appended claims.

What is claimed:

1. Training system software operable on a digital computer for providing training to operator trainees of underground storage tank containing facilities that is capable of delivering facility specific training materials applicable to an operator-trainee's designated facility, the software comprising:
(a) generic content component training materials for providing training applicable to a plurality of facilities including the operator trainee's designated facility;
(b) at least two sets of regional content component training materials, each of the at least two sets for providing training applicable to at least two, but less than the plurality of facilities to which the generic content component training materials are applicable, and at least one of the sets including regional content materials applicable to the designated facility of the operator-trainee; and
(c) at least four sets of facility specific component training materials, each of the at least four sets including facility specific content material applicable to a single facility, and one of the at least four sets including facility specific content material applicable to the operator trainee's designated facility.

2. The training system software of claim 1 further comprising a testing component capable of creating a test for the operator-trainee relating to the training materials that are facility specific for the operator trainee's, designated facility, the testing component including test questions relating to each of the generic content component training materials, the regional content component training materials, and the set of the facility specific content material applicable to the operator trainee's designated facility.

3. The training system software of claim 2 wherein the testing component includes a test generator for assembling a test for an operator trainee that includes a plurality of test questions, the test questions including generic content test questions, regional content test questions and facility specific questions, all of which are appropriate for the operator trainee's designated facility.

4. The training system software of claim 3 wherein the test generator includes a randomizing function for assembling the test questions in a manner wherein the test questions assembled for a first operator-trainee of a designated facility will differ from the test questions assembled for a second operator-trainee's designated facility.

5. The training system software of claim 1 wherein the plurality of facilities for which the generic content materials are applicable comprise at least four facilities.

6. The training system software of Claim I wherein the software includes a client accessible database that is accessible by personnel of a company operating the plurality of facilities, the client accessible database including trainee personnel data, trainee certification status data, and facility specific information.

7. The training system software of claim 1 wherein the software includes a regulator accessible database accessible by personnel from a governmental regulatory authority, the regulator accessible database containing information relating to, and capable of providing a report to a regulator that includes information relating to: identification information about operators of at least one particular designated facility, and certification status information about the operator of the at least one particular designated facility.

8. The training system software of claim 1 wherein the software includes a communication component for permitting communication between a remote computer and the software, to permit access to the software by at least three persons selected from the group consisting of supervisory personnel of multi-facility, operating company, regulatory agency personnel, operator trainee personnel, facility management personnel, and training company personnel.

9. The training system software of claim 1 wherein the software includes an accounting module capable of determining when an event has occurred for which a payment is due from a customer, and preparing an invoice to the customer for the event for which a payment is due.

10. The training system software of claim 9 further comprising a certification management module capable of communicating with the accounting module for determining whether to issue a certification based upon a payment status of the operator trainee seeking certification.

11. The training system software of claim 10 wherein the certification management component includes a database of certifications granted to the operator trainees, the database including expiration dates of the certifications and designated facilities to which the certifications apply.

12. The training system software of claim 11 further comprising a calendaring component capable of generating reminder notices based upon the expiration dates for forwarding to an appropriate party prior to the expiration date.

13. The training system software of claim 1 further comprising a certification management module for containing and managing information concerning the certification status of operator-trainees, the certifications applicable to particular designated facilities, and the expiration dates of certifications granted to operator trainees.

14. The training system of claim 13 further comprising an accounting module in communication with the certification management module, for permitting the training system software to grant a certification in response to a receipt of payment for training provided to the operator trainee.

15. The training system of claim 1 further comprising a calendaring component capable of generating reminder notices relating to certificate expiration dates.

16. The training system software of claim 1 wherein the training system software includes a field maintenance application for facilitating the inclusion of facility specific information into the training system software.

17. The training system software of claim 16 wherein the field management application includes facility identification information, and safety item information relating to the nature and location of facility specific safety items.

18. The training system software of claim 17 wherein the safety item information includes both textual and graphical information relating to safety items, wherein the textual information includes information about the location of safety items, and the graphical information includes at least one picture of a safety item.

19. The training system software of claim 17 wherein the training system software includes an integrator for integrating the facility specific safety item information of the field management application into the facility content component training materials.

20. The training system software of claim 1 further comprising a testing module for generating test questions for an operator trainee, including generic content test questions, regional content test questions and facility specific test questions, and for scoring an operator trainee's responses to the test questions to determine whether the operator trainee's responses qualify the operator trainee for certification, and
a certification management module capable of communicating with the testing module for granting certification to an operator trainee upon a determination that the operator trainee's responses to the test questions qualify the operator trainee for certification.
